(19) United States
(12) Patent Application Publication
(10) Pub. No.: US 2025/0042266 A1
(43) Pub. Date: Feb. 6, 2025

(54) ELECTRICALLY DRIVEN CRAWLER-TYPE VEHICLE PLATFORM FOR FARM WORKING

(71) Applicant: THE INDUSTRY & ACADEMIC COOPERATION IN CHUNGNAM NATIONAL UNIVERSITY (IAC), Daejeon (KR)

(72) Inventors: Yong Joo KIM, Daejon (KR); Jun Ho LEE, Incheon (KR)

(21) Appl. No.: 18/716,157

(22) PCT Filed: Oct. 12, 2022
(86) PCT No.: PCT/KR2022/015330

§ 371 Date: Jun. 4, 2024

(30) Foreign Application Priority Data
Dec. 7, 2021 (KR) 10-2021-0173949

(51) Int. Cl. B60L 50/60; B60H 1/00

(52) U.S. Cl. CPC B60L 50/60; B60H 1/00278; B60L 2200/40

(57) ABSTRACT

The present invention relates to an electrically driven crawler-type vehicle platform for farm working, which can transmit large driving force to the left and right of a track by placing a battery pack and connecting each of an electric powered actuator and an hydraulic actuator to wheels and a three-point hitch, and enables easy control of the three-point hitch for attachment of a rear working machine, the platform comprising: a battery pack (100) for supplying power to a crawler-type vehicle for farm working; a wheel driving unit (200) for driving a wheel by the power received from the battery pack (100); and three-point hitch driving unit 300 for driving the three-point hitch by the power received from the battery pack (110).

### TECHNICAL FIELD

The present disclosure relates to an electrically driven crawler-type vehicle platform for farm working, that is, an electrically driven crawler-type vehicle platform for farm working, which can transmit large driving force to left and right of a track by placing a battery pack and connecting each of an electric-powered actuators and an hydraulic actuator to wheels and a three-point hitch, and enables easy control of the three-point hitch for attachment of a rear working machine.

### BACKGROUND ART

As a prior art regarding an electrically driven vehicle platform for farm working, there has been disclosed a technology about a control apparatus for a fuel cell vehicle system in Korean Patent No. 10-0821787 (registered Apr. 4, 2008), the control apparatus being characterized in that a power line is connected between an inverter of a power steering system and an energy storage system and a vehicle control unit activates the power line of the inverter and the energy storage system when a shutdown instruction is given while a vehicle is driven so that steering is possible by the power steering system until the vehicle is stopped.

Further, there has been disclosed a technology about a battery system that can circulate an insulating oil without an actuator requiring power, and a working machine having the battery system in Korean Patent Application Publication No. 10-2020-0095126 (published Aug. 10, 2020), the battery system being characterized by including: an external battery box accommodating a battery module therein; an insulating oil filled in the external battery box; and a circulator disposed in the external battery box and circulating the insulating oil, in which the circulator includes: hollow body having an inlet pipe through which the insulating oil flows inside and an outlet pipe through which the insulating oil is discharged; a weight disposed in the body to slide in the longitudinal direction of the body by inertia; and a first elastic member elastically supporting the portion between an end of the body and the weight.

Further, there has been disclosed a technology about an agricultural electric vehicle in Korean Patent Application Publication No. 10-2014-0136072 (published Nov. 28, 2014), the agricultural electric vehicle including: a main frame having a seat formed transversely in the electric vehicle; a sliding tray installed on the seat; a battery pack equipped with battery cells transversely moving into and out of the seat; and a side cover installed on a side of the main frame and being selectively attached/detached when the battery pack equipped with the battery cells is moved into and out of the main frame.

Further, there has been disclosed a technology about an electrically-driven agricultural work vehicle in Korean Patent No. 10-1302407 (registered Aug. 27, 2013), the electrically-driven agricultural work vehicle being an electric agricultural vehicle that is moved by electricity as power and being characterized in that a battery pack composed of a large number of battery cells is detachably mounted on a body frame under a front wheel-side bonnet space protected by a bonnet, a motor for generating power is mounted on the body frame extending rearward from the battery pack, and a transmission is disposed at the rear end of the body frame behind the motor close to rear wheels to be directly connected with the motor such that power can be transmitted.

### CITATION LIST

### Patent Literature

[Patent Literature 1]
Korean Patent No. 10-0821787 (registered Apr. 4, 2008)
[Patent Literature 2]
Korean Patent Application Publication No. 10-2020-0095126 (published Aug. 10, 2020)
[Patent Literature 3]
Korean Patent Application Publication No. 10-2014-0136072 (published Nov. 28, 2014)
[Patent Literature 4]
Korean Patent No. 10-1302407 (registered Aug. 27, 2013)

### SUMMARY OF INVENTION

### Technical Problem

The present disclosure relates to a configuration and a structure platform of a crawler-type vehicle platform for farm working that can be electrically driven, and an objective of the present disclosure is to obtain large driving force from small power using an electric powered actuator in caterpillar driving.

Further, an objective of the present disclosure is to enable easy rotating and turning and efficient distribution of power by independently driving left and right tracks.

Further, an objective of the present disclosure is to connect a three-point hitch for attachment of a rear working machine using an hydraulic actuator such that the position can be adjusted.

### Solution to Problem

In order to achieve the objectives, the present disclosure relates to [1] an electrically driven crawler-type vehicle platform for farm working that includes: a battery pack (100) for supplying power to a crawler-type vehicle for farm working; a wheel driving unit (200) for driving a wheel using power received from the battery pack (100); and a three-point hitch driving unit (300) for driving a three-point hitch using power received from the battery pack (100).

Further, the present disclosure relates to the electrically driven crawler-type vehicle platform of [1], in which [2] the wheel driving unit (200) includes: an electric powered actuator for driving left and right wheels using power received from the battery pack (100); and reducers (220) for reducing power received from the electric powered actuator (210).

Further, the present disclosure relates to the electrically driven crawler-type vehicle platform of [1] or [2], in which [3] the three-point hitch driving unit (300) includes: an hydraulic actuator (310) transmitting power, which is received from the battery pack (100), to an hydraulic cylinder; and a three-point hitch (330) that is driven by the hydraulic cylinder.

Further, the present disclosure relates to the electrically driven crawler-type vehicle platform of [3], in which [4] an air-cooled cooler (110) for cooling the battery pack (100) is further installed at the front of the battery pack (100).

Further, the present disclosure relates to the electrically driven crawler-type vehicle platform of [4], in which [5] the electric powered actuator and the hydraulic actuator are controlled by a controller (not shown).

### Advantageous Effects of Invention

Since the present disclosure has the configuration described above, in a configuration and a structure platform of an electrically driven crawler-type vehicle platform for farm working, it is possible to obtain large driving force from small power using an electric powered actuator in caterpillar driving.

Further, the present disclosure enables easy rotating and turning and efficient distribution of power by independently driving left and right tracks.

Further, the present disclosure can easily adjust the position of a three-point hitch for attachment of a rear working machine using an hydraulic actuator.

### BRIEF DESCRIPTION OF DRAWINGS

FIG. 1 is conceptual view of the present disclosure.

FIG. 2 is a conceptual diagram of a battery unit of the present disclosure.

### DESCRIPTION OF EMBODIMENTS

The present disclosure relates to an electrically driven crawler-type vehicle platform for farm working comprising a battery pack 100 for supplying power to a crawler-type vehicle for farm working, a wheel driving unit 200 for driving a wheel using power received from the battery pack 100, and a three-point hitch driving unit 300 for driving a three-point hitch using power received from the battery pack 100, and the components are described hereafter in detail with reference to the drawings.

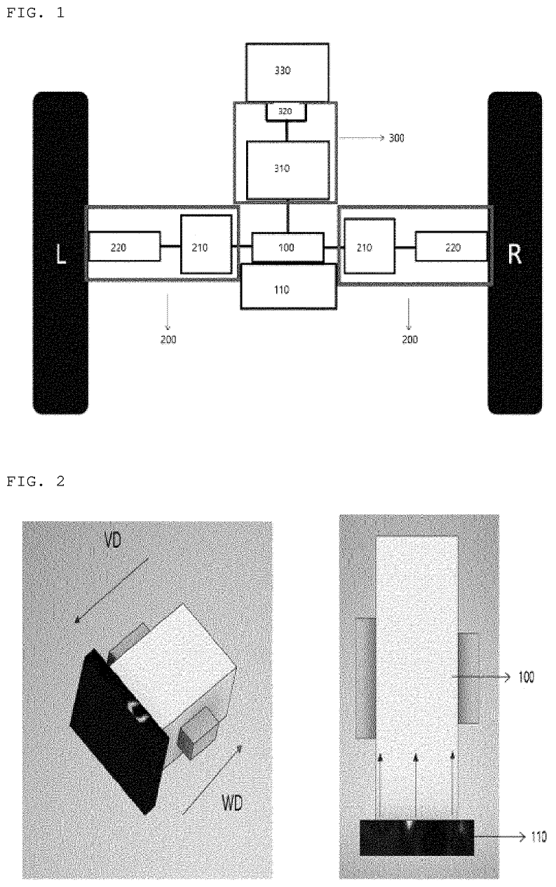

The present disclosure, as shown in FIG. 1, includes a wheel driving unit 200 for driving wheels R and L and a three-point hitch driving unit 300 driving a three-point hitch 330 which use power supplied from the battery pack 100.

The battery pack 100 of the present disclosure is a component for supplying power to the wheels R and L and the three-point hitch 330, so it is preferable to dispose the battery pack 100 at the lower portion of the center of the crawler-type vehicle for farm working.

Further, since the battery pack 100 generates heat when driving a vehicle, as shown in FIG. 2, a cooler is installed at the front side in the driving direction VD of the vehicle. Accordingly, the cooler and the battery pack 100 are installed in a wind direction WD. In this configuration, it is preferable that the cooler is an air-cooled cooler 110 to reduce the danger of explosion. In this configuration, operation of the air-cooled cooler 110 can be controlled using natural wind that accompanies driving of a vehicle or power that is supplied from the battery pack 100.

The wheel driving unit 200 of the present disclosure, as shown in FIG. 1, includes electric powered actuators 210 respectively driving the left and right wheels R and L using power received from the battery pack 100 and reducers 220 for reducing power received from the electric powered actuators 210.

As described above, it is possible to independently control driving of the wheels R and L through a controller (not shown) by installing an electric powered actuator 210 and a reducer 220 for each of the wheels R and L, so a user can easily control driving, reversing, turning, and rotating of a vehicle for farm working.

The three-point hitch driving unit 300 of the present disclosure, as shown in FIG. 1, includes an hydraulic actuator 310 transmitting power, which is received from the battery pack 100, to an hydraulic cylinder 320, and a three-point hitch 330 that is driven by the hydraulic cylinder 320.

Further, the reason of providing power for driving the three-point hitch 330 to the hydraulic actuator 310 is because a user can easily control the direction of hydraulic and a flow rate through a control valve.

Further, an hydraulic actuator can automatically control the direction of hydraulic and a flow rate depending on input systems, which can reduce a burden on a user.

Although the present disclosure was described with reference to the exemplary drawings, it is apparent that the present disclosure is not limited to the embodiments and drawings in the specification and may be modified in various ways by those skilled in the art within the range of the spirit of the present disclosure. Further, even though the operation effects according to the configuration of the present disclosure were not clearly described with the above description of embodiments of the present disclosure, it is apparent that effects that can be expected from the configuration should be also admitted.

### REFERENCE SIGNS LIST

100: Battery pack
110: Air cooled cooler
200: Wheel driving unit
210: Electric actuator
220: Reducer
300: Three-point hitch driving unit
310: Hydraulic actuator
320: Hydraulic cylinder
330: Three-point hitch
400: Controller
VD: Driving direction of vehicle
WD: Wind direction

1. An electrically driven crawler-type vehicle platform for farm working, comprising:
a battery pack for supplying power to a crawler-type vehicle for farm working;
a wheel driving unit for driving a wheel using power received from the battery pack; and
a three-point hitch driving unit for driving a three-point hitch using power received from the battery pack.

2. The electrically driven crawler-type vehicle platform of claim 1, wherein the wheel driving unit includes:
an electric powered actuator for driving left and right wheels using power received from the battery pack; and
a reducer for reducing power received from the electric powered actuator.

3. The electrically driven crawler-type vehicle platform of claim 1, wherein the three-point hitch driving unit includes:
An hydraulic actuator transmitting power, which is received from the battery pack, to an hydraulic cylinder; and
a three-point hitch that is driven by the hydraulic cylinder.

4. The electrically driven crawler-type vehicle platform of claim 3, wherein an air-cooled cooler for cooling the battery pack is further installed at the front of the battery pack.

5. The electrically driven crawler-type vehicle platform of claim 4, wherein the electric powered actuator and the hydraulic actuator are controlled by a controller.
